(19) United States
(12) Patent Application Publication
(10) Pub. No.: US 2016/0178153 A1
(43) Pub. Date: Jun. 23, 2016

(54) Projection module for a headlight of a vehicle

(71) Applicant: HELLA KGAA HUECK & CO., Lippstadt (DE)

(72) Inventors: Waldemar Petker, Bünde (DE); Alexander Wehner, Bad Münster a. St.- Ebernburg (DE)

(21) Appl. No.: 14/898,666

(22) PCT Filed: Aug. 12, 2014
(86) PCT No.: PCT/EP2014/067223

§ 371 Date: Dec. 15, 2015

(30) Foreign Application Priority Data
Aug. 13, 2013 (DE) 10 2013 108 746.9

(51) Int. Cl. F21S 8/10

(52) U.S. Cl. CPC F21S 48/1216; F21S 48/1305; F21S 48/142

(57) ABSTRACT

A projection module for a headlight of a vehicle with a lens holder for receiving a projection lens. On the lens holder is arranged a reflector on which can be received a light source. The lens holder comprises locking tabs, into which can lock counter-locking means provided on the reflector by moving the reflector to the lens holder from an axial direction (A) so that the latching connection is formed for a holding arrangement of the reflector on the lens holder. A headlight of a vehicle may include such a projection module. A method for the mounting of the projection module is also envisioned.

The present invention relates to a projection module for a headlight of a vehicle with a lens holder holding a projection lens, wherein on the lens holder is arranged a reflector and wherein a light source can be accommodated at a reflector. The invention further relates to a headlight of a vehicle with such a projection module and a method for mounting the projection module.

### PRIOR ART

EP 2 385 298 A1 shows an example of a projection module for a headlight of a vehicle with a lens holder in which a projection lens can be locked. On the lens holder is arranged a reflector, wherein the reflector is designed to accommodate a lighting means, such as a halogen lamp or a xenon lamp. The projection module can be configured for advance lighting with a low beam, for which a further low beam shield is provided, which is arranged between the lens holder and the reflector. The connection between the lens holder and the reflector is established by a bayonet lock and on the opening side of the lens holders, on which reflector is arranged, the lens holder has positioning means for positioning the shield and rotary locking means for pivotal connection with a front edge of the reflector. If the reflector is arranged by the bayonet connection on the lens holder, the rotary locking means engage with flange-type retaining lugs radially extending away from the reflector, whereby a positive connection between the lens holder and the reflector is formed.

The disadvantage is that manual assembly of the reflector on the lens holder is not possible without an auxiliary device, and with a view to increasingly important localizability of conventional projection modules, the classic bayonet connection followed by the turning of the securing lugs is a crucial disadvantage. In particular, this type of connection requires a device that performs and supports the joining process. As a consequence, existing modules can be moved only with an increased effort. In addition to low process reliability and increased assembly costs, tolerances between the reflector, the lens holder and the seat of the reflector on the lens holder can be only partly compensated. In particular, if an additional low beam is provided between the lens holder and the reflector, further tolerances add up that cannot be compensated by a bayonet lock.

### DISCLOSURE OF THE INVENTION

The object of the invention is further development of a projection module that can be assembled in a simple manner and enables process-safe, easy mounting of the reflector on the lens holder in particular with tolerance compensation.

This object is achieved starting from a projection module for a headlight of a vehicle according to the preamble of claim 1, starting from a headlight for a vehicle according to the preamble of claim 7 and starting from a method of assembling a projection module according to claim 8 with the respective characterizing features dissolved. Advantageous developments of the invention are specified in the dependent claims.

This invention involves the technical teaching that the lens holder comprises locking tabs, where counter-locking means provided on the reflector can be locked by moving the reflector to the lens holder from an axial direction so that a locking connection for a holding arrangement of the reflector on the lens holder is formed.

Due to the inventive formation of a snap-in connection between the lens holder and the reflector, the reflector can be introduced in a simple manner from an axial direction into the lens holder and snapped to it. The counter-locking means for locking the reflector engage with the locking tabs on the lens holder, wherein the locking connection may comprise one or more pairs of locking tabs and counter-locking means, for example, around the circumference of the reflector. The axial direction can correspond to the axis of symmetry of the reflector and optionally to the axis of symmetry of the lens holder, and the axial direction forms at the same time the main light projection axis of the module. The locking tabs allow a secure connection of the reflector to the lens holder by cooperating in a form-fitting manner with the counter-locking means on the reflector, and at the same time the locking tabs allow tolerance compensation, and no separate device is required for the establishment of the locking connection, and the joining of the reflector to the lens holder can be done manually or automatically.

Advantageously, the lens holder is formed by a plastic component, wherein the locking tabs may be formed in one piece on the lens holder. The lens holder can be in particular a plastic injection-molded component, and the locking tabs can already be formed by an appropriate geometry of the injection-molding tool for the plastic injection molding.

The locking tabs can have a spring section which is adapted to carry out an elastic deformation upon the latching of the counter-locking means in the locking tabs. When the counter-locking means is latched on the latching lug, the spring portion can compensate for tolerances occurring in the position of the counter-locking means relative to the locking tab; in addition, the spring section allows an approximately constant holding force of the locking tabs to the counter-locking means irrespective of tolerances.

Advantageously, the reflector can comprise a sheet metal component which forms the reflector, for example, in connection with a further plastic component, or the sheet metal component already forms the reflector of its own. The counter-locking means can be formed by lugs formed on the sheet metal component and bent with a radius contour. Due to the radius contour in the lugs, during the joining process of the reflector to the lens holder, the locking tabs can slide on the radius contour of the lugs, while the spring section snaps in during the engagement process. When the snap-in connection between the locking tabs and the mating locking means is established, the locking tabs engage in particular with the ends of the spring sections with the bent lugs, which leads to a form-fitting connection with elastic spring action by the spring sections.

According to a further advantageous embodiment of the projection module, on the lens holder can be formed at least one catch that extends into the axial direction in a catching recess on the reflector when the reflector is arranged on the lens holder. The catch formation can be configured for example as a dome-shaped projection on the joint surface of the lens holder, and the catching recess can form a hole in the edge of the reflector, into which the catch extends when the reflector is arranged on the lens holder. Here, two or more catch formations can be provided with the associated catch recesses to ensure an accurate positioning of the reflector on the lens holder. The catch formation in connection with the catch recess can be provided so that an incorrect assembly of the reflector on the lens holder can be excluded.

According to a further advantageous embodiment of the projection module, it can comprise a low beam shield that must to be arranged between the reflector and the lens holder. Here, the low beam shield can be arranged being snapped by the latching connection between the lens holder and the reflector. It can also be provided that the low beam shield is attached to the reflector before the snap of the reflector on the lens holder, for example, by riveting or latching, so that the reflector can be latched together with the low beam shield according to the present invention in the lens holder.

The object of the invention is further achieved by a headlight for a vehicle with a projection module received in a housing of the headlight comprising a lens holder for receiving a projection lens and comprising a reflector arranged on the lens holder, and on which a light source can be accommodated, wherein a supporting frame is provided with which the projection module is received in the housing of the head light. According to the invention, the lens holder can have locking tabs, in which are latched the counter-locking means provided on the reflector, and wherein screw elements can be provided with which the lens holder is screwed together with at least the reflector to the supporting frame. The locking tabs are no longer loaded when the reflector is screwed with the screw elements to the lens holder. Thus, the locking connection according to the invention can also be provided only as an assembly aid until the lens holder together with the reflector are screwed to the supporting frame.

The object of the present invention is further achieved by a method for mounting a projection module for a headlight of a vehicle, wherein the projection module comprises a lens holder for receiving a projection lens and a reflector on which a luminous means can be arranged, and wherein the reflector is disposed at the lens holder, which is designed to accommodate a light source, and wherein said method comprises at least the steps of moving the reflector to the lens holder in an axial direction, and the locking of the counter-locking means existing on the reflector in the locking tabs on the lens holder so that a latching connection is formed for a holding arrangement of the reflector on the lens holder.

The method may advantageously include the installation of a low beam shield that can be arranged on the reflector prior to moving the reflector to the lens holder, or the low beam shield is placed in the lens holder before moving the reflector. Further, the projection module can comprise a projection lens, which is arranged on the latter before the reflector is moved to the lens holder, in particular latched in the lens holder. Further, another shield element, for example a so-called OS shield, can be latched to the lens holder.

### PREFERRED EMBODIMENT OF THE INVENTION

Further measures improving the invention are represented in greater detail below together with the description of a preferred embodiment of the invention with reference to figures. The figures show:

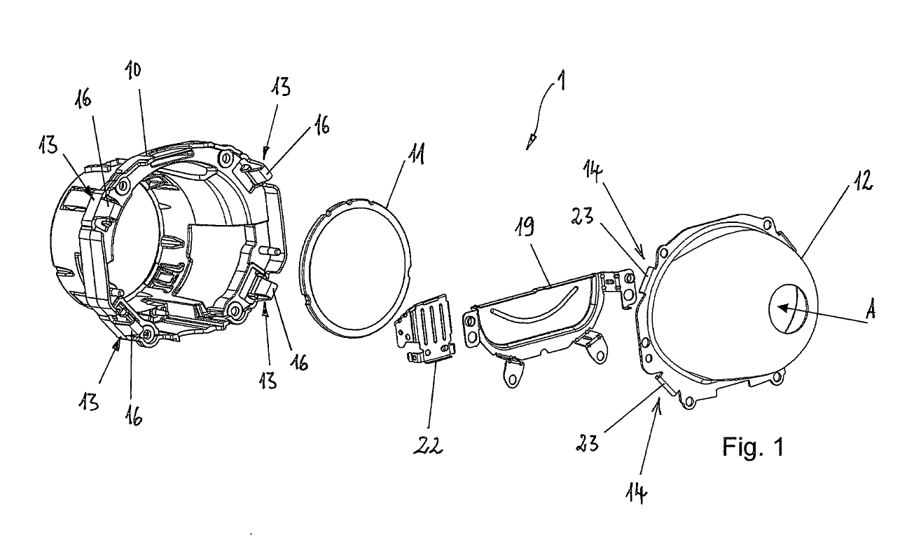

FIG. 1 shows a perspective, flying view of the essential components for forming a projection module having the features of the present invention,

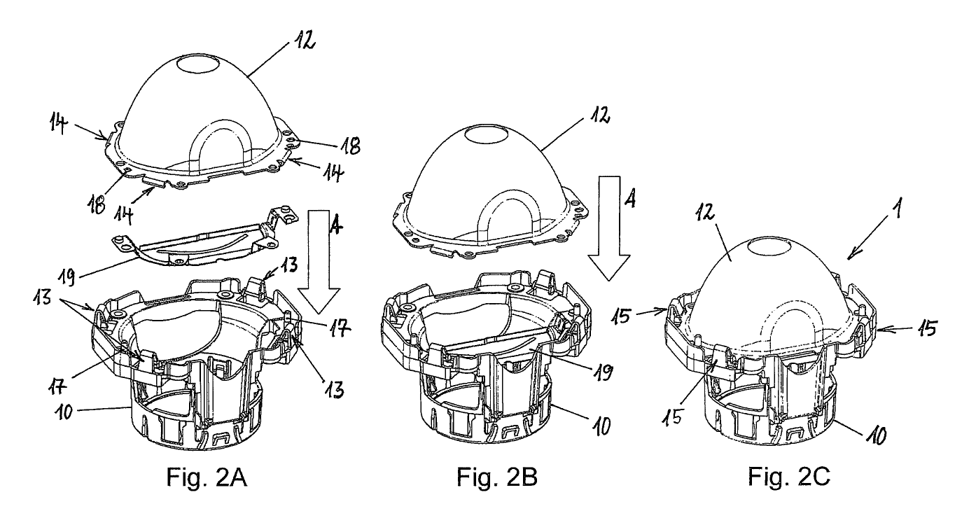

FIG. 2A shows a flying view of the components of the projection module before a joining process,

FIG. 2B shows a flying view of the components of the projection module in a partially joined arrangement,

FIG. 2C shows the projection module in joined arrangement,

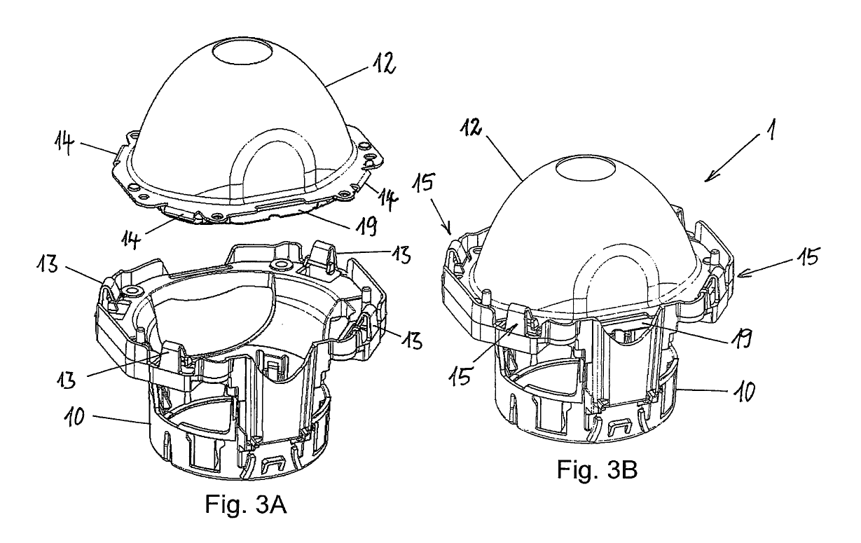

FIG. 3A shows a perspective view of the projection module prior to the joining step according to another variant of joining,

FIG. 3B shows the module according to FIG. 3A in a joined arrangement,

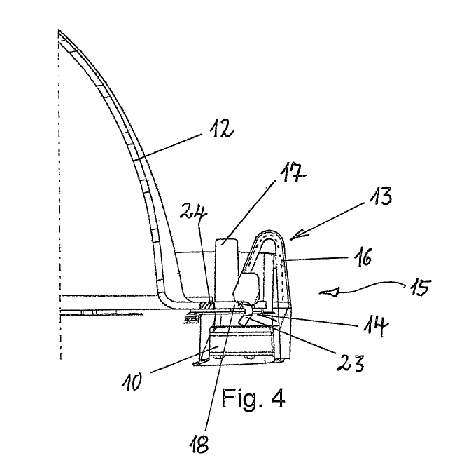

FIG. 4 shows a detailed view of the locking connection with the locking tabs on the lens holder and the counter-locking means on the reflector,

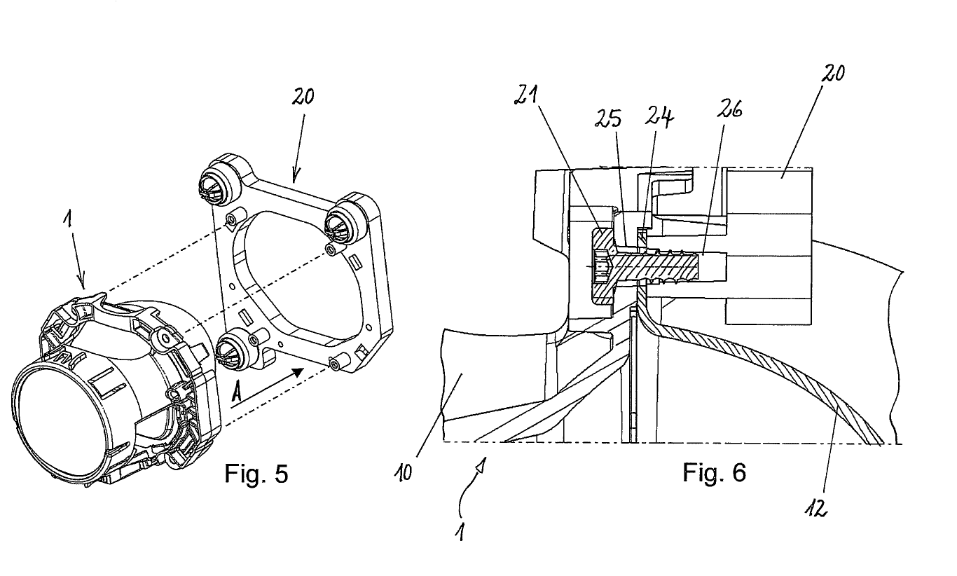

FIG. 5 shows a perspective view of the projection module in conjunction with a supporting frame,

FIG. 6 shows a detailed view of the screwing of the projection module to the supporting frame together with the reflector.

FIG. 1 shows in a flying view the components of the projection module 1 with the features of the present invention. The projection module 1 serves as a light module for installation in the housing of a headlight of a vehicle that is designed as a projection module 1 with a projection lens 11. A lens holder 10 serves to arrange the projection lens in a defined position in front of a reflector 12, which is designed to accommodate a light source, for example a halogen or a xenon bulb, and the projection lens 11 can be locked in the lens holder 10 and the reflector 12 is arranged in a holding position on the lens holder 10. Further showed are a low beam shield 19, which is positioned in an arrangement between the reflector 12 and the projection lens 11, and there is shown shield element 22, which is used to form a so-called OS shield and can also be locked in the lens holder 10.

According to the invention, the reflector 12 can be introduced from the shown axial direction A into the lens holder 10. To mount the projection modules 1, first the projection lens 11 is latched inside the lens holder 10, after which the shield element 22 is also arranged in the lens holder 10. Subsequently, the low beam shield 19 can be arranged either on reflector 12 or inserted into the joint side of the lens holders 10. In a subsequent joining step, reflector 12 is moved from the axial direction into the lens holder 10 and locked thereto.

For locking of the reflector 12 on the lens holder 10, the lens holder 10 comprises locking tabs 13 which can form latching connections with counter-locking means 14 on the reflector 12. The locking tabs 13 have a spring section 16 so that the locking tabs 13 can spring back during the joining process, and so that the locking tabs 13 can engage in the counter-locking means 14 formed as bent lugs 23. When the counter-locking means 14 are latched in the locking tabs 13, the projection module 1 can already be used.

FIGS. 2A, 2B and 2C show a first variant of joining the projection module 1 as shown in FIG. 2C so that the reflector 12 is arranged on the lens holder 10 by generating a plurality of latching connections 15.

FIG. 2a shows first in a flying view the components of the light module 1 according to FIG. 2C, and the reflector 12 is shown above the lens holders 10, and between the reflector 12 and the lens holder 10 is arranged the low beam shield 19. The joining direction corresponds to the axial direction A shown, from which the reflector 12 is guided to the lens holder 10. Here, the locking tabs 13 on the lens holder 10 and the counter-locking means 14 on the reflector 12 are so aligned to each other in a rotational position that the counter-locking means 14 can engage with the locking tabs 13. Further, the lens holder 10 is formed with catch formations 17, which extend dome-shaped against the axial direction A. Furthermore, the reflector 12 comprises catching recesses 18, and when the reflector 12 is joined to the lens holder 10, the catch formations 17 can engage with the catching recesses 18.

FIG. 3A shows a further joining variant to form a projection module 1 according to FIG. 3B, which comprises a reflector 12 which is locked by several latching connections 15 to a lens holder 10, and wherein between the reflector 12 and the lens holder 10 is the low beam shield 19. FIG. 3a shows the reflector 12 in a floating view over the lens holder 10, wherein in a preceding joining step the low beam shield 19 has already been arranged on reflector 12 so that the reflector 12 together with the low beam shield 19 are ready as a single component group for the subsequent joining step.

For joining, the reflector 12 is aligned relative to the lens holder 10 in its rotational direction so that the counter-locking means 14 are facing the locking tabs 13 in order to subsequently carry out the joining step, by which the positive connection of the latching connections 15 is formed by a form-fitting closure of the engagement of the locking tabs 13 behind the counter-locking means 14, as shown in more detail in connection with the following FIG. 4.

FIG. 4 shows a cross section through a latching connection 15, such as it can be established the present invention, in a simple or multiple arrangement, between the lens holder 10 and the reflector 12. The cross-section shows the lens holder 10 with the locking lug 13 formed on it, and there is a reflector 12 shown, which is formed from a metal sheet element. The reflector 12 has as a front outer edge a reflector flange 24, and on each of the reflector flanges 24 are formed lugs 23 bent with a radius contour for the formation of each of the latch connections 15. These lugs 23 can snap behind the locking tabs 13 so that the lugs 23 are held in a form-fitting manner between the catch tab 13 and the contact surface of the lens holders 10. At the same time, the catch formation 17 can extend through the catch recess 18, which is also incorporated in the reflector flange 24.

When the reflector 12 is moved to the lens holder 10, first the external side of the lug 23 reaches with its radius contour the locking tab 13. In case of a continuing joint movement there arises an elastic deformation of the spring section 16 until the end face of the locking tab 13 is guided along the lug 23 to ultimately again snap up behind the lug 23, which occurs under elastic recoiling in the spring section 16. Here, the latch connection 15 can be formed so that after a single latching of the reflector 12 on the lens holder 10, it can no longer be released due to the formed positive connection.

FIG. 5 shows a further development of the inventive projection modules 1, which can be arranged on a supporting frame 20 by the projection module 1 being moved in the shown axial direction A to supporting frame 20.

FIG. 6 shows a joint spot between the projection module 1 and the supporting frame 20, and the connection is produced by several screw elements 21, wherein the section view shows a screw element 21. The screw element 21 extends through a through-hole 25 in the lens holder 10 and is screwed in a threaded hole 26 in the supporting frame 20. Here, the reflector 12 is already screwed in, and the reflector flange 24 extends into the joining zone between the lens holder 10 and the supporting frame 20. In this way, the locking connection 15 between the lens holder 10 and the reflector 12 can be supported or even replaced by a screw connection of the projection modules 1 on the support frame 20 so that a vibration-proof connection between the projection module 1 and the supporting frame 20 resilient to a high mechanical stress can be established, wherein at the same time the arrangement of the reflector 12 and also the arrangement of the low beam shield 19 by the screw connection 21 on the lens holder can be ensured in a manner not shown in detail.

The invention is not limited to the above-described preferred embodiment. Rather, a number of variants are conceivable, which uses the described solution even for basically different configurations. All of the previous features and/or advantages, including design details, spatial configurations and procedural steps resulting from the claims, the description or the drawings, can be essential to the invention as they are or in arbitrary combinations.

### LIST OF REFERENCE NUMERALS

1 Projection module
10 Lens holder
11 Projection lens
12 Reflector
13 Locking tab
14 Counter-locking means
15 Latching connection
16 Spring section
17 Catch formation
18 Catch recess
19 Low beam shield
20 Supporting frame
21 Screw element
22 Shield element
23 Lug
24 Reflector flange
25 Through hole
26 Threaded hole
A Axial direction

1. A projection module for a headlight of a vehicle comprising:
a lens holder for receiving a projection lens, wherein on the lens holder (10) is arranged a reflector (12) and wherein on the reflector (12) can be accommodated a light,
wherein the lens holder comprises locking tabs, in which can lock counter-locking means provided on the reflector by moving the reflector to the lens holder from an axial direction (A) so that a latching connection can be established for a holding arrangement of the reflector on the lens holder.

2. The projection module according to claim 1 wherein the lens holder is formed by a plastic component, wherein the locking tabs are formed on the lens holder as one component.

3. The projection module according to claim 1 wherein the locking tabs comprise a spring section, which is formed for the execution of an elastic deformation after the counter-locking means lock in den locking tabs.

4. The projection module according to claim 1 wherein the reflector includes a metal sheet component, wherein the counter-locking means are formed by lugs bent in radius contour and formed on the metal sheet component.

5. The projection module according to claim 1 wherein at least one catch formation is arranged on the lens holder, which extends in an axial direction (A) into a catch recess on the reflector, when the reflector is arranged on the holder.

6. The projection module according to claim 1 wherein a low beam shield is provided, which can be arranged being clamped, in a latching connection between the lens holder and the reflector.

7. A headlight for a vehicle comprising:
a projection module accommodated in a housing of the headlight, said projection module including:
a lens holder for accommodating a projection lens;
a reflector arranged on the lens holder and in which can be received a light source,
a supporting frame, with which the projection module is held in the housing of the headlight,
wherein the lens holder comprises locking tabs, in which are latched the counter-locking means provided on the reflector, and
wherein the screw elements are provided, with which the holder together with at least the reflector are screwed to the supporting frame.

8. A method for the mounting of a projection module for a headlight of a vehicle, wherein the projection module comprises a lens holder for receiving a projection lens and a reflector, on which can be arranged a light source, and wherein the reflector is arranged on the lens holder, which is designed for receiving a light source, and wherein the method comprises at least the following steps:
moving the reflector to the lens holder from an axial direction (A),
latching the counter-locking means existing on the reflector in the locking tab arranged on the lens holder so that a latching connection is established for a holding arrangement of the reflector on the lens holder.

9. The method according to claim 8, characterized in that wherein a low beam shield is provided, which:
is arranged in a holding position on the reflector before the reflector is moved to the lens holder or which
is inserted into the lens holder before moving the reflector.

10. The method according to claim 8 wherein before moving the reflector to the lens holder, another shield element is arranged and preferably snapped-in on the lens holder.
